(19) United States
(12) Patent Application Publication
(10) Pub. No.: US 2026/0035942 A1
(43) Pub. Date: Feb. 5, 2026

(54) CLEAN ROOM SYSTEM

(71) Applicant: LOCUS CELL CO., LTD., New Taipei City (TW)

(72) Inventors: Heng-Yu Liu, New Taipei City (TW); Wei-Ting Lin, New Taipei City (TW)

(21) Appl. No.: 19/273,180

(22) Filed: Jul. 18, 2025

Related U.S. Application Data
(60) Provisional application No. 63/677,142, filed on Jul. 30, 2024.

(51) Int. Cl. E04H 1/12; B25J 21/00; F24F 3/167

(52) U.S. Cl. CPC E04H 1/12; B25J 21/005; F24F 3/167

(57) ABSTRACT

A clean room system comprises a plurality of clean room modules, a plurality of docking windows and an automated guided vehicle. Each of the clean room modules comprises a plurality of partitions. The partitions are configured for quick assembly to form an internal space and an external area. The docking windows are disposed on the partitions within each of the clean room modules respectively. Each of the docking windows is configured to serve as a channel between the corresponding internal space and the external area. The automated guided vehicle is operated in the external area and is configured to transport an item through the channel corresponding to the docking window. Compared with the prior art, the invention of the clean room system can be applied to cell factories, allowing for quick and flexible arrangement of production lines and routes, thereby improving production efficiency within the cell factory.

### BACKGROUND OF THE INVENTION

### 1. Field of the Invention

The present invention relates to a clean room system, and more particularly, to a clean room system for quick assembly applied to a Contract Development and Manufacturing Organization (CDMO) cell factory.

### 2. Description of the Prior Art

In recent years, with advancement in biotechnology and medical engineering, the demand for cell therapy in clinical applications has increased significantly. Especially in the field of regenerative medicine, cell therapy has the potential to treat diseases that were once considered untreatable, such as diabetes, neurologic disorders, cardiovascular diseases and cancer, and to provide patients with additional treatment options. Otherwise, as cell therapy products continue to develop and mature, the market is placing increasing demands on large-scale and standardized production, leading to a growing need for cell factories.

Due to the fact that the active ingredient in the cell therapy products is live cells, the cell therapy manufacturing industry faces several challenges regarding the standardization and specificity of these products. For example, the growing conditions of cells can be influenced by various factors comprising cell sources, culture reagents, culture environment, culture procedures, personnel skills and the complexity of the manufacturing process. Moreover, culture protocols and the appropriate environmental conditions and parameters for each cell type are different, thereby necessitating the rearrangement of the laboratory zones according to cell specificity. In addition, variability in cell culture protocols caused by human subjectivity and operational errors among different operators increases uncertainty in the production process, leading to reduced production stability and efficiency.

Moreover, the manufacturing process of the cell therapy products in prior art requires the transportation of raw material and waste. The risk of cross-contamination increases, resulting in reduced product quality and increased difficulty in quality control within the factory when raw material and waste cannot be efficiently separated.

Otherwise, equipment used for cell therapy products in prior art faces challenges related to scheduled maintenance. The production schedule can be affected, resulting in total production line shutdowns, increased time costs and increased management pressure when the equipment in some laboratory zones undergoes scheduled maintenance or repair works. In the production model of the prior art, scheduled maintenance lacks flexibility and cannot be adjusted according to different customer orders and equipment conditions, thereby affecting the overall production timeline.

Therefore, there is an urgent need to develop a novel clean room system that can quickly adjust production scheduling according to production demands and solve the production problem regarding cross-contamination between raw material and waste and scheduled maintenance.

### SUMMARY OF THE INVENTION

Therefore, the present invention provides a clean room system comprising a plurality of clean room modules, a plurality of docking windows and an automated guided vehicle. Each of the clean room modules comprises a plurality of partitions. The partitions are configured for quick assembly to form an internal space and an external area. The docking windows are disposed on the partitions within each of the clean room modules respectively. Each of the docking windows is configured to serve as a channel between the corresponding internal space and the external area. The automated guided vehicle is operated in the external area and is configured to transport an item through the channel corresponding to the docking window.

Wherein, the clean room system is applied to a cell factory, and the cell factory is a Contract Development and Manufacturing Organization (CDMO) cell factory. Each of the partitions is a movable partition, and the internal space in each of the clean room modules is an airtight space; the internal space in each of the clean room modules achieves a target level of air tightness by maintaining the airtight space under a condition of positive pressure and laminar flow.

Wherein, the clean room system further comprises a main pneumatic-electric delivery device and a plurality of cell incubators. The cell incubators are disposed in one of the clean room modules, and the main pneumatic-electric delivery device is disposed on one of the movable partitions within the clean room module. The main pneumatic-electric delivery device is connected to the clean room modules and the cell incubators.

Wherein, the main pneumatic-electric delivery device further comprises a gas line unit and a wire unit. The main pneumatic-electric delivery device serves as a unified supply source for the cell incubators according to the gas line unit and the wire unit.

Wherein, each of the docking windows further comprises a first docking window and a second docking window, and the item further comprises a first item and a second item. The automated guided vehicle is configured to transport the first item to the internal space through the first docking window and transport the second item to the external area through the second docking window, and the geometric shape of the first docking window is different from that of the second docking window.

Wherein, each of the clean room modules further comprises a mechanical arm. The mechanical arm comprises a first gripper and a second gripper, and the first gripper is configured to grip the first item and the second gripper is configured to grip the second item.

Wherein, the mechanical arm is configured to AI visual identify and position the first item, the second item, the first docking window, the second docking window and the cell incubators.

Wherein, the mechanical arm further comprises a gravity sensor unit, and the gravity sensor unit is configured to identify the first item and the second item.

Wherein, the first item is raw material, and the second item is waste.

Wherein, the clean room modules quickly disassemble the movable partitions according to a scheduled maintenance and a production schedule when the scheduled maintenance and the production schedule are coordinated by the cell factory.

In summary, the invention of the clean room module within the clean room system can quickly and flexibly assemble or disassemble the movable partitions according to the production scheduling of the Contract Development and Manufacturing Organization (CDMO) cell factory, allowing for optimal production line configuration. In addition, the present invention separates the docking windows according to transported items. For example, raw material can be transported using the specific automated guided vehicle, and then passed through the docking window with a corresponding geometric shape, thereby avoiding the risk of cross-contamination between raw material and waste. Furthermore, the invention of each of the clean room modules within the clean room system is independent and isolated. Therefore, the invention of the clean room system can achieve independent or staggered scheduled maintenance according to the scheduled maintenance cycle of equipment within each of the clean room modules when the clean room system is applied to the Contract Development and Manufacturing Organization (CDMO) cell factory, which comprises equipment requiring scheduled maintenance. The invention of the clean room system can further adjust each laboratory zone and automated guided vehicle route according to the current scheduling. Compared with the prior art, the present invention of the clean room system can solve the issue of total production line shutdown due to scheduled maintenance and flexibly adjust each of the clean room modules according to the production line plan to improve the production capacity of the whole cell factory.

The invention of each of the clean room modules within the clean room system further comprises a mechanical arm. The mechanical arm can confirm the accuracy of raw material transportation through AI visual identification and perform precise cell culture operations. Compared with the prior art, the invention of the clean room system cannot only improve the production capacity but also maintain the production yield. In addition, the invention of the clean room system further comprises a main pneumatic-electric delivery device disposed in a specific clean room module. The main pneumatic-electric delivery device serves as a unified supply source for each of the cell incubators, thereby reducing the cumbersome verification requirements after replacing a cell incubator and improving the efficiency of the cell culture operations and production.

### BRIEF DESCRIPTION OF THE APPENDED DRAWINGS

FIG. 1 is a schematic diagram illustrating the clean room system according to an embodiment of the present invention.

FIG. 2 is a schematic diagram illustrating the docking windows according to an embodiment of the present invention.

FIG. 3A is a schematic diagram illustrating the clean room system according to another embodiment of the present invention.

FIG. 3B is a schematic diagram illustrating the clean room system according to another embodiment of the present invention.

FIG. 3C is a schematic diagram illustrating the clean room system according to another embodiment of the present invention.

FIG. 4 is a schematic diagram illustrating the clean room modules according to another embodiment of the present invention.

FIG. 5 is a schematic diagram illustrating the clean room modules according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

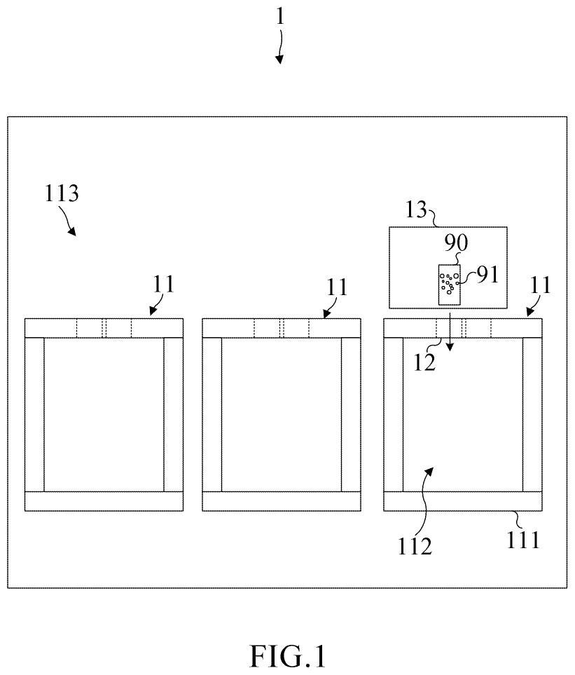

Please refer to FIG. 1. FIG. 1 is a schematic diagram illustrating the clean room system 1 according to an embodiment of the present invention. As shown in FIG. 1, in this specific embodiment, the clean room system 1 comprises a plurality of clean room modules 11, a plurality of docking windows 12 and an automated guided vehicle 13. Each of the clean room modules 11 comprises a plurality of partitions 111. The partitions 111 are configured for quick assembly to form an internal space 112 and an external area 113. The docking windows 12 are disposed on the partitions 111 within each of the clean room modules 11 respectively. Each of the docking windows 12 is configured to serve as a channel (not shown in figure) between the corresponding internal space 112 and the external area 113. The automated guided vehicle 13 is operated in the external area and is configured to transport an outer box 90 that contains an item 91 through the channel corresponding to the docking window 12.

In practice, the clean room system 1 is applied to a cell factory, which is a Contract Development and Manufacturing Organization (CDMO) cell factory. Wherein, each of the partitions is a movable partition, and the partition material can be stainless steel, aluminum alloy, high-pressure laminate (HPL), or other composite materials. Each of the partitions can be quickly assembled and disassembled with others using joint components such as sealing strips, snap-fits, or coupling clips. Furthermore, the internal space that is composed of partitions in each of the clean room modules is an airtight space. The clean room grade of the internal space in each of the clean room modules reaches Grade 4 (i.e. in compliance with ISO Class 8 standards) by maintaining the airtight space under a condition of positive pressure and laminar flow. In practice, the partition material and the joint component are not limited to this; they can be adjusted by the production requirements and standards.

For example, there are medical stainless steels surrounding each of the partitions, and the stainless steels can be fixed on the outer of the partitions by slot or embedded design. The partitions are coupled together using the snap-fit component (such as snap-fits, coupling clips, concealed joints, and magnetic fasteners) to achieve stable connection and air tightness. In another specific embodiment, each of the partitions has interlocking structures along its perimeter, and airtight strips are applied on the surface of each of the interlocking structures. The partitions are securely coupled together according to the interlocking structures and the airtight strips. In another specific embodiment, the invention of the clean room system further comprises tracks, a circuit module, and a sensor disposed in the cell factory. The invention of the clean room system can automatically transport the partitions to the target location using the circuit module and the tracks. Furthermore, the sensor can detect the air tightness of the partition panel joints in real time. Therefore, the invention of the clean room system can not only improve the assembly and disassembly efficiency of the partitions but also quickly arrange space for production, and automatically assemble a plurality of internal space to enhance the flexibility and production efficiency of the cell factory.

Furthermore, the partitions, which can be assembled and disassembled, enable each of the clean room modules to be independent and isolated. Therefore, when the present invention is applied to the Contract Development and Manufacturing Organization (CDMO) cell factory and the equipment in the cell factory requires performing scheduled maintenance, the invention of the clean room system can adjust the number of clean room modules. It can also relocate the clean room modules to different locations for scheduled maintenance according to the duration or status of scheduled maintenance for equipment. On the other hand, the invention of the clean room system can achieve independent or staggered scheduled maintenance according to equipment within each of the clean room modules. In addition, the invention can also rearrange each of the clean rooms within cell factory and automated guided vehicle route according to the current scheduling. In this way, the invention of the clean room system can not only efficiently avoid the total production line shutdown caused by scheduled maintenance, but also relocate the clean room modules within the cell factory to optimal positions or quickly disassemble them to accommodate internal production line arrangement when scheduled maintenance is required in the cell factory. Hence, the invention of the clean room system enhances route flexibility within the cell factory and enables necessary adjustments in response to future market demands, thereby helping the cell factory maintain a stable level of production capacity.

The internal chamber of the automated guided vehicle (AGV) can be maintained under a condition of positive pressure and laminar flow to ensure the safety and cleanliness of items during transportation when the automated guided vehicle is used in the cell factory. The internal chamber of the automated guided vehicle comprises a sterilization device, such as hydrogen peroxide sterilization and ultraviolet (UV) disinfection, to avoid cross-contamination. Furthermore, the automated guided vehicle can also interface with various specialized equipment comprising isolator, restricted-access barrier systems (RABS), biological safety cabinets (BSC) and material airlocks (MAL). Therefore, the aforementioned automated guided vehicle can further separate raw material and waste. In another embodiment, the automated guided vehicle can display corresponding signal lights and indicator lights according to the item transported to avoid confusion. Otherwise, the automated guided vehicle further comprises a particle-monitoring sensor. The particle-monitoring sensor can detect the particle concentration around the automated guided vehicle in real time to ensure that the environmental cleanliness meets the standard during operation. Furthermore, the automated guided vehicle comprises an intelligent scheduling module. The intelligent scheduling module can automatically assign transport tasks according to equipment power status and internal chamber sterilization status to improve the transport efficiency within the cell factory.

The invention of the automated guided vehicle can transport the item using the following methods. In one specific embodiment, the clean room system comprises a predefined track. The automated guided vehicle can run along the predefined track to transport the item. The predefined track can be a magnetic strip or a physical track to ensure that the automated guided vehicle runs along a fixed path. In another specific embodiment, the automated guided vehicle can move freely without relying on the physical track within the Contract Development and Manufacturing Organization (CDMO) cell factory by using laser-guided paths, visual recognition, and a system-defined internal map of the CDMO cell factory for localization. Therefore, the automated guided vehicle can handle the flexible scheduling and the modification in the internal layout of the CDMO cell factory. In another specific embodiment, the automated guided vehicle can be integrated with the central control system of the CDMO cell factory. The central control system can control the transportation and manage the scheduling of the automated guided vehicle through remote operation. In addition, the central control system can further monitor the operating status and the power status of the automated guided vehicle. Therefore, the invention can not only enhance the transport efficiency but also monitor the transport route and scheduling of the automated guided vehicle for potential errors by being integrated with the central control system of the CDMO cell factory, thereby enabling high-efficiency, high-accuracy and automated transportation of raw material and waste.

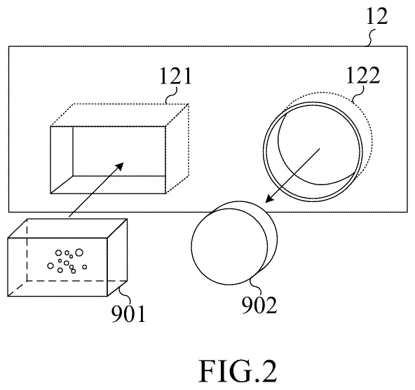

Please refer to FIG. 2. FIG. 2 is a schematic diagram illustrating the docking windows 12 according to an embodiment of the present invention. As shown in FIG. 2, each of the docking windows 12 further comprises a first docking window 121 and a second docking window 122. It is worth noting that the geometric shape of the first docking window 121 is different from that of the second docking window 122. As shown in FIG. 2, the geometric shape of the first docking window 121 is rectangle, and the geometric shape of the second docking window 122 is circle; the cross-sectional of the first outer box 901 that contains the first item is rectangle, and the cross-sectional of the second outer box 902 that contains the second item is circle. The automated guided vehicle can transport the first item (such as the raw material) to the internal space through the first docking window 121 and transport the second item (such as the waste) to the external area through the second docking window 122. Therefore, the shape difference between the first docking window and the second docking window facilitates identification during transportation and prevents the automated guided vehicle from incorrect transporting and retrieving item, thereby improving the operational accuracy of the cell factory. In another specific embodiment, the clean room system comprises a first automated guided vehicle and a second automated guided vehicle transporting different types of items respectively. For example, the first automated guided vehicle transports the first item (such as the raw material) to the internal space through the first docking window; the second automated guided vehicle transports the second item (such as the waste) to the external area through the second docking window. Therefore, the present invention of the clean room system can not only increase the transport accuracy of the items but also decrease the risk of cross-contamination.

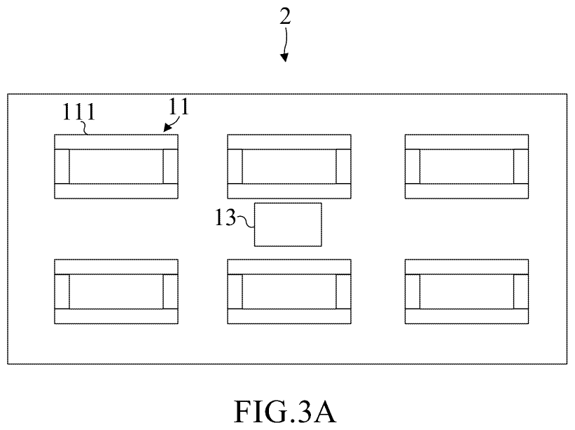

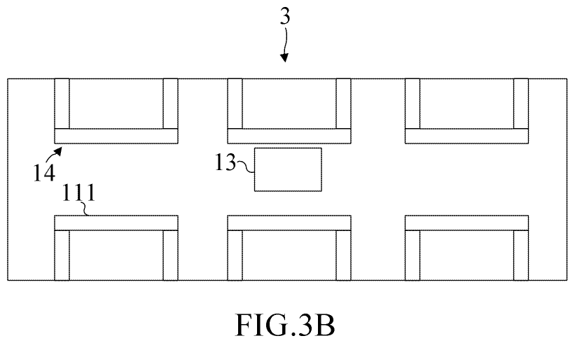

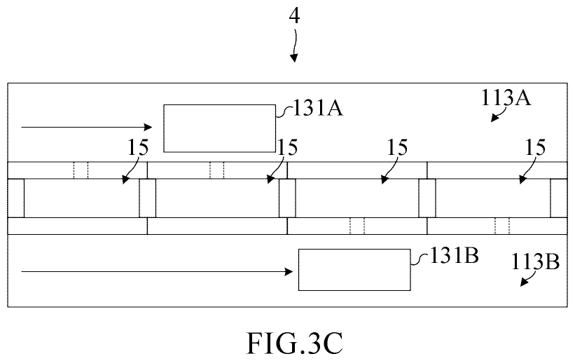

Furthermore, the present invention provides various forms of the clean room system to respond to the production requirements of various manufacturing modes. Please refer to FIG. 3A, FIG. 3B and FIG. 3C. FIG. 3A is a schematic diagram illustrating the clean room system 2 according to another embodiment of the present invention. FIG. 3B is a schematic diagram illustrating the clean room system 3 according to another embodiment of the present invention. FIG. 3C is a schematic diagram illustrating the clean room system 4 according to another embodiment of the present invention. Please note that, for the sake of clarity in the drawings, FIG. 3A, FIG. 3B and FIG. 3C only show the clean room system, the partitions and the automated guided vehicle. As shown in FIG. 3A, in this specific embodiment, the number of partitions 111 used in each of the clean room systems 11 is four, and the number of clean room modules 11 in the clean room system 2 is six. The automated guided vehicle 13 can be operated in the external area and automatically transport the item (such as raw material) to the target clean room module according to the scheduling. As shown in FIG. 3B, in this specific embodiment, the number of partitions 111 used in each of the clean room systems 14 is three, and the number of clean room modules 14 in the clean room system 3 is six. The automated guided vehicle 13 can be operated in the external area and automatically transport the item (such as raw material) to the target clean room module according to the scheduling. As shown in FIG. 3C, in this specific embodiment, each of the clean room modules 15 shares the partitions 111 with its neighboring module, and the number of clean room modules 15 is four. Wherein, the docking windows of some clean room modules 15 are disposed in a first external area 113A, and the docking windows of other clean room modules 15 are disposed in a second external area 113B. The first automated guided vehicle 131A is only operated in the first external area 113A, and transport the specific item (such as the raw material). The second automated guided vehicle 131B can be only operated in the second external area 113B, and transport the specific item (such as the waste). In addition, the first automated guided vehicle 131A and the second automated guided vehicle 131B can also be operated along the direction indicated by the arrow shown in FIG. 3C. Therefore, the invention of the clean room system can adjust the number of partitions according to the production requirements to form various configuration types, thereby maximizing space utilization in the CDMO cell factory. Furthermore, the invention can flexibly update, adjust and arrange the production line and the route of the automated guided vehicle according to scheduled maintenance for different equipment, thereby satisfying various production demands within the cell factory. Please note that the number of partitions in the invention of the clean room system is not limited to this. In another embodiment, a large clean room module can be formed by using three partitions per side, with four sides in total.

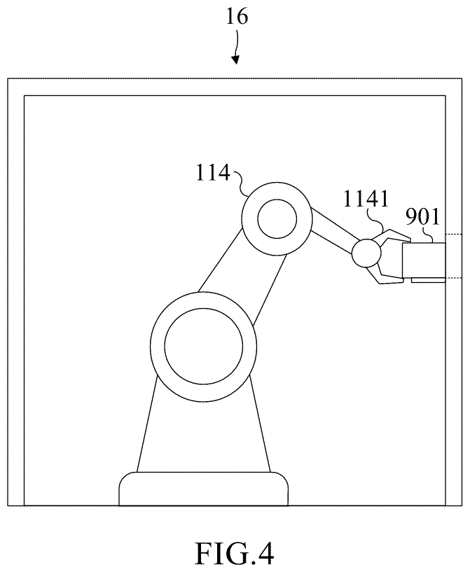

Please refer to FIG. 4. FIG. 4 is a schematic diagram illustrating the clean room modules 16 according to another embodiment of the present invention. As shown in FIG. 4, each of the clean room modules 16 further comprises a mechanical arm 114, and the mechanical arm 114 comprises a first gripper 1141 and a second gripper (not shown in figure). The first gripper 1141 is configured to grip a first outer box 901 that contains the first item and the second gripper is configured to grip a second outer box that contains the second item. In practice, the mechanical arm 114 can identify the first item, the second item, the first outer box, the second outer box, the first docking window, the second docking window and the cell incubators through AI visual identification. Moreover, the mechanical arm 114 can automatically replace the gripper corresponding to the raw material and the waste (this refers to the first item and the second item) to avoid cross-contamination. Therefore, the invention of the clean room system can efficiently re-confirm that the first outer box transported from the first docking window is correct, and perform precise cell culture and other cell protocols within each of the clean room modules, thereby efficiently increasing the yield and quality standards in the cell factory.

The mechanical arm can identify items through AI visual identification. For example, the mechanical arm can identify the transported raw material and the waste to conduct a verification process. In practice, AI visual identification can collect images and photos related to the raw material and the waste, and extract features after labeling through machine learning techniques such as convolutional neural network (CNN). Then, the features of the raw material and the waste are used to classify and localized objects. Furthermore, the mechanical arm can identify and analyze the raw material through AI visual identification, which can be integrated with the system in the mechanical arm to enable precise positioning of cells in the cell dish and perform operations such as micro-injection, medium addition and cell separation. Therefore, the invention of the clean room system can quickly achieve automation and perform precise operations, efficiently improving production yield and reducing the risk of contamination associated with manual operations in the prior art.

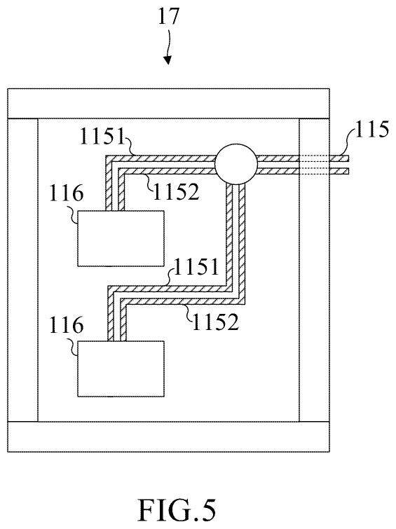

Furthermore, the cell manufacturing process may be taken place on more than one floor in a large CDMO cell factory. The quality of the material is affected by the cleanliness of the internal space, the transportation process and the environment standards at the destination after transporting when the cell material is moved from one floor to another. Hence, the present invention provides the other embodiment. Please refer to FIG. 5. FIG. 5 is a schematic diagram illustrating the clean room modules 17 according to another embodiment of the present invention. The clean room system further comprises a main pneumatic-electric delivery device 115 and a plurality of cell incubators 116. As shown in FIG. 5, in this specific embodiment, the cell incubators 116 are disposed in one of the clean room modules 17. The main pneumatic-electric delivery device 115 is disposed on one of the movable partitions within the clean room module 17, and the main pneumatic-electric delivery device 115 can be connected to the external main electrical cable installation. In practice, since two cell incubators 116 are disposed in the clean room module 17 and the clean room module 17 is assembled using movable partitions, two cell incubators 116 do not need to be removed. Instead, they can be relocated together with the clean room module 17 to other floors when the cell incubators 116 of the clean room module 17 need to be moved to different floors in order to meet production demands. Therefore, the cell incubators 116 cannot be contaminated due to relocation. Furthermore, the main pneumatic-electric delivery device 115 of the clean room system 17 can directly be connected to the circuit and the gas line of the floor when the clean room module 17 is moved. This is because the main pneumatic-electric delivery device 115 is disposed on the clean room system 17 and simultaneously connected to two cell incubators 116 within the clean room module. The air pressure for the two cell incubators 116 within the clean room system 17 can be supplied by the standard gas and power supply of the building according to the gas line unit 1151 and the wire unit 1152 of the main pneumatic-electric delivery device 115 after the main pneumatic-electric delivery device 115 is connected to the circuit and the gas line of the floor. Therefore, the invention can not only ensure the stability of the gas and power supply within the clean room system but also satisfy various production requirements of the cell factory. Please note that the number of cell incubator is two in this specific embodiment; however, the number and the size of the cell incubator and the specifications of the main pneumatic-electric delivery device can be adjusted and designed according to user requirements in practice.

In summary, the invention of the clean room module within the clean room system can quickly and flexibly assemble or disassemble the movable partitions according to the production scheduling of the Contract Development and Manufacturing Organization (CDMO) cell factory, allowing for optimal production line configuration. In addition, the present invention separates the docking windows according to transported items. For example, raw material can be transported using the specific automated guided vehicle, and then passed through the docking window with a corresponding geometric shape, thereby avoiding the risk of cross-contamination between raw material and waste. Furthermore, the invention of each of the clean room modules within the clean room system is independent and isolated. Therefore, the invention of the clean room system can achieve independent or staggered scheduled maintenance according to the scheduled maintenance cycle of equipment within each of the clean room modules when the clean room system is applied to the Contract Development and Manufacturing Organization (CDMO) cell factory, which comprises equipment requiring scheduled maintenance. The invention of the clean room system can further adjust each laboratory zone and automated guided vehicle route according to the current scheduling. Compared with the prior art, the present invention of the clean room system can solve the issue of total production line shutdown due to scheduled maintenance and flexibly adjust each of the clean room modules according to the production line plan to improve the production capacity of the whole cell factory.

The invention of each of the clean room modules within the clean room system further comprises a mechanical arm. The mechanical arm can confirm the accuracy of raw material transportation through AI visual identification and perform precise cell culture operations. Compared with the prior art, the invention of the clean room system can not only improve the production capacity but also maintain the production yield. In addition, the invention of the clean room system further comprises a main pneumatic-electric delivery device disposed in a specific clean room module. The main pneumatic-electric delivery device serves as a unified supply source for each of the cell incubators, thereby reducing the cumbersome verification requirements after replacing a cell incubator and improving the efficiency of the cell culture operations and production.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A clean room system, comprising:
a plurality of clean room modules respectively comprising a plurality of partitions, the partitions being configured for quick assembly to form an internal space and an external area;
a plurality of docking windows disposed on the partitions within each of the clean room modules respectively, each of the docking windows being configured to serve as a channel between the corresponding internal space and the external area; and
an automated guided vehicle operated in the external area and configured to transport an item through the channel corresponding to the docking window.

2. The clean room system of claim 1, wherein the clean room system is applied to a cell factory, the cell factory is a Contract Development and Manufacturing Organization (CDMO) cell factory, each of the partitions is a movable partition, the internal space in each of the clean room modules is an airtight space, the internal space in each of the clean room modules achieves a target grade of air tightness by maintaining the airtight space under a condition of positive pressure and laminar flow.

3. The clean room system of claim 2, further comprising a main pneumatic-electric delivery device and a plurality of cell incubators, the cell incubators being disposed in one of the clean room modules, and the main pneumatic-electric delivery device being disposed on one of the movable partitions within the clean room module, the main pneumatic-electric delivery device being connected to the clean room modules and the cell incubators.

4. The clean room system of claim 3, wherein the main pneumatic-electric delivery device further comprises a gas line unit and a wire unit, the main pneumatic-electric delivery device serves as a unified supply source for the cell incubators according to the gas line unit and the wire unit.

5. The clean room system of claim 3, wherein each of the docking windows further comprises a first docking window and a second docking window, the item further comprises a first item and a second item, the automated guided vehicle is configured to transport the first item to the internal space through the first docking window and transport the second item to the external area through the second docking window, and the geometric shape of the first docking window is different from that of the second docking window.

6. The clean room system of claim 5, wherein each of the clean room modules further comprises a mechanical arm, the mechanical arm comprises a first gripper and a second gripper, the first gripper is configured to grip the first item and the second gripper is configured to grip the second item.

7. The clean room system of claim 6, wherein the mechanical arm is configured to AI visual identify and position the first item, the second item, the first docking window, the second docking window and the cell incubators.

8. The clean room system of claim 6, wherein the mechanical arm further comprises a gravity sensor unit, the gravity sensor unit is configured to identify the first item and the second item.

9. The clean room system of claim 5, wherein the first item is raw material, the second item is waste.

10. The clean room system of claim 2, wherein the clean room modules quickly disassemble the movable partitions according to a scheduled maintenance and a production schedule when the scheduled maintenance and the production schedule are coordinated by the cell factory.
